(19) United States
(12) Patent Application Publication
(10) Pub. No.: US 2004/0061390 A1
(43) Pub. Date: Apr. 1, 2004

(54) Apparatus and method for connecting parallel stator windings

(76) Inventors: Shawn Lawrence Baker-Bachman, Morrison, CO (US); Darin L. Denton, Idaho Springs, CO (US); Jeff Frazzini, Westminster, CO (US); Josh Ley, Lakewood, CO (US)

Correspondence Address: BURNS, DOANE, SWECKER & MATHIS, L.L.P., P.O. Box 1404, Alexandria, VA, 22313-1404, US

(21) Appl. No.: 10/260,460

(22) Filed: Oct. 1, 2002

(51) Int. Cl. H02K 11/00

(52) U.S. Cl. 310/71

(57) ABSTRACT

An polyphase machine includes a stator having a plurality of parallel stator windings, a plurality of phase voltage terminals, each of the stator windings fastened to a corresponding phase voltage terminal, and at least one neutral terminal, each of the stator windings forming a common ground fastened to the neutral terminal. At least one of the stator windings is fastened to the corresponding phase voltage terminal or neutral terminal by a connection that does not involve a heat induced joining method. In an exemplary embodiment, the connection includes a lead wire protruding from the stator winding and terminated with a connector, such as a ring lug, fastened to the respective terminal with a mechanical fastener, such as a rivet or threaded rivet. A method for connecting stator windings in a polyphase machine is also provided.

### BACKGROUND OF THE INVENTION

1. Field of the Invention

The present invention relates to connections for parallel stator windings in a polyphase machine. In addition, the present invention relates to a connection between a terminal ring and the stator windings that does not involve a heat induced joining method, is a two part connection, or is reconnectable.

2. Discussion of Related Art

In the discussion of the related art that follows, reference is made to certain structures and/or methods. However, the following references should not be construed as an admission that these structures and/or methods constitute prior art. Applicant expressly reserves the right to demonstrate that such structures and/or methods do not qualify as prior art against the present invention, if appropriate.

Stator winding arrangements in electrical machines include groupings of wire coils, wherein one end of each coil is a voltage phase input and the other end of each coil is commonly coupled.

Such multiple grouping stator windings are cumbersome in their manufacture. For example, in a common three phase, four pole, AC induction motor, twelve individual coils are required. Thus, twelve coil terminals, one terminal from each coil, are commonly coupled. A variety of methods are practiced to accomplish this task, among them being wire splicing, electrical clips secured by solder, soldering, brazing, and combinations thereof. Such joining methods require insulation of such coupling joints to prevent shorting to other portions of the stator windings and/or, since the neutral is electrically floating, to prevent shorting to other portions of the stator and/or motor housing structures.

Machines that use a ring-type termination usually use an insulator that is designed to follow the general shape of at least a portion of the end of the stator. For example, in U.S. Pat. No. 5,508,571, the insulator is generally disc shaped and has a number of passages through it for routing the neutral leads. Immediately adjacent the insulator and opposite of the stator, a neutral lead conductor is placed, which is also shaped to follow at least a portion of the general shape of the stator end. In the '571 patent, neutral lead termination sites at the conductor are structures, such as a tower portion, post, stud, or substantially normal extending structure, about which the neutral lead conductor may be secured by brazing.

In conventional ring-type terminations, long wires are used to make the connection and the wires are first insulated then wrapped around the stator end windings to make each connection. This method also leads to uneven heat and electrical conduction, and unwanted heat generation due to the resistance in the wire, which can decrease the efficiency of the machine.

### SUMMARY

The present invention provides an apparatus and a method for connecting parallel stator windings in a polyphase machine. In an exemplary embodiment, a polyphase machine comprises a stator having a plurality of parallel stator windings, a plurality of phase voltage terminals, each of the stator windings fastened to a corresponding phase voltage terminal, and at least one neutral terminal, each of the stator windings forming a common ground fastened to the neutral terminal. At least one of the stator windings is fastened to the corresponding phase voltage terminal or neutral terminal by a connection that does not involve a heat induced joining method.

As used herein, the term “solderless” connection shall mean any type of connection that does not include soldering, brazing, or any other heat induced joining method wherein a connection is formed, secured, or enhanced by the use of heated or molten metal.

In another exemplary embodiment of the present invention, a polyphase machine comprises a stator having a plurality of stator windings, a plurality of phase voltage terminals, each of the stator windings fastened to a corresponding phase voltage terminal, and at least one neutral terminal, each of the stator windings forming a common ground fastened to the neutral terminal. At least one of the stator windings is fastened to the corresponding phase voltage terminal or neutral terminal by a mechanical connection including a mechanical fastener selected from the group consisting of a threaded fastener and a blind fastener.

In an exemplary embodiment, the phase voltage terminals are a series of three concentric rings having a common axis with the stator. The neutral terminal is a single ring having a common axis with the stator.

In a further exemplary embodiment, a polyphase machine comprises a stator having a plurality of parallel stator windings, a plurality of phase voltage terminals, each of the stator windings fastened to a corresponding phase voltage terminal, and at least one neutral terminal, each of the stator windings forming a common ground fastened to the neutral terminal. At least one of the stator windings is fastened to a respective terminal with a two part connection, the two part connection including a connector secured to an end of the at least one stator winding and a fastener for securing the connector to the respective terminal, and the fastener does not use a heat induced joining method.

An exemplary method of the present invention for connecting parallel stator windings in a polyphase machine having a plurality of stator windings comprises electrically connecting a lead wire protruding from a stator winding and terminated with a connector to a corresponding phase voltage terminal with a mechanical fastener, and electrically connecting a neutral terminal end of at least one stator winding to a neutral terminal. In a preferred embodiment, the connecting step does not use a heat induced joining method.

### BRIEF DESCRIPTION OF THE DRAWING FIGURES

Aspects and advantages of the invention will become apparent from the following detailed description of preferred embodiments thereof in connection with the accompanying drawings in which like numerals designate like elements and in which:

FIG. 1 shows a perspective view of a polyphase machine as seen from a phase voltage end.

FIG. 2 shows the exemplary embodiment of the FIG. 1 apparatus as seen from a neutral terminal end.

FIG. 3 shows a portion of a terminal with a lead secured thereto.

FIG. 4 shows a portion of a terminal of FIG. 3 from the opposite side thereof.

### DETAILED DESCRIPTION OF THE PREFERRED EMBODIMENTS

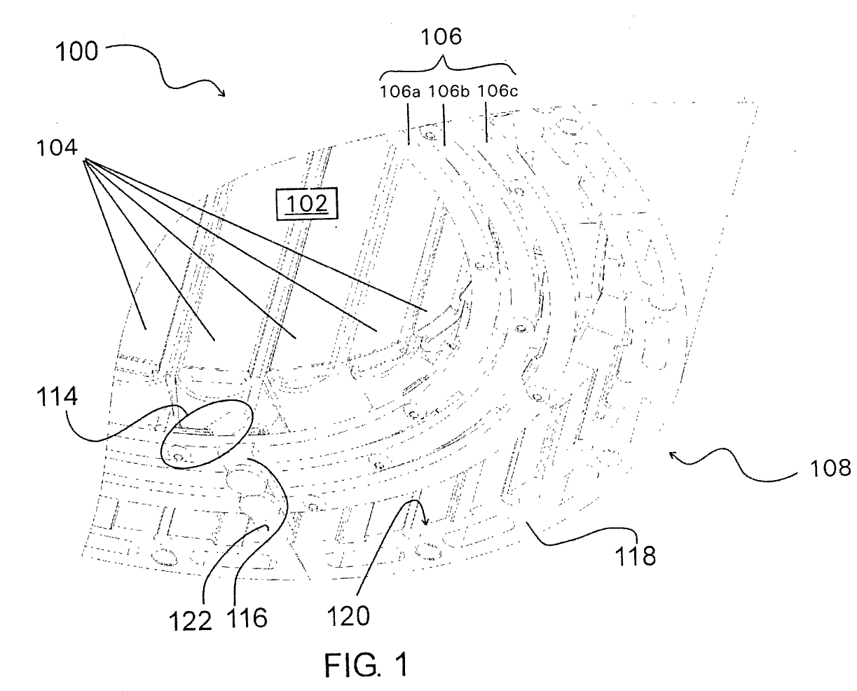

An exemplary embodiment of a polyphase machine, e.g., machines with more than one electrical phase such as AC induction motors, permanent magnet motors, and other electrical machines, is shown in FIG. 1 as polyphase machine 100. The polyphase machine 100 comprises a stator 102 having a plurality of parallel stator windings 104. A phase voltage terminal arrangement 106, including a plurality of phase voltage terminals 106a, 106b, 106c, is at the phase voltage end 108 and a neutral terminal 110 is at the neutral terminal end 112. Each of the phase voltage terminals 106a, 106b, 106c is fastened to one or more of the stator windings 104 having a common phase that corresponds to a separate phase of the polyphase machine 100. The neutral terminal 110 is fastened to each of the stator windings 104 forming a common ground. At least one of the stator windings 104 is fastened to the corresponding phase voltage terminal 106a, 106b, 106c or neutral terminal 110 by a connection 114. In an exemplary embodiment, the at least one stator winding, and preferably all of the stator windings, is fastened to the corresponding phase voltage terminal 106a, 106b, 106c or neutral terminal 110 by a connection 114 that does not involve a heat induced joining method.

In the exemplary embodiments shown and described herein, the polyphase machine 100 is referred to as having a phase voltage end 108 and a neutral terminal end 112, and the phase voltage end 108 and the neutral terminal end 112 are further referred to as aligned axially. For example, FIG. 1 shows the phase voltage end 108 of the polyphase machine 100. However, it should be understood that this description is merely exemplary and that polyphase machines having a common end for both the phase voltage and the neutral terminal are envisioned. In such polyphase machines the phase voltage termination scheme and neutral terminal termination scheme include appropriate electrical leads from the stator windings terminated with a connector that can be fastened to the corresponding terminal with a mechanical fastener.

A plurality of phase voltage terminals 106a, 106b, 106c are at the phase voltage end 108. The phase voltage terminals 106a, 106b, 106c preferably have a common axis with the stator 102 and preferably have a general shape corresponding to the radial cross section of the stator. In an exemplary embodiment, the phase voltage terminals are a series of concentric rings having a common axis with the stator 102. Three concentric rings 106a, 106b, 106c are shown in the exemplary embodiment of FIG. 1, but any number of rings can be used where each ring is common to a corresponding separate phase of the polyphase machine 100. For example, the phase voltage terminals are preferably concentrically placed inside each other with an insulating spacer 116 separating each phase voltage terminal. The outermost concentric ring 106c is preferably no larger in diameter than the outer diameter of the stator 102 and the innermost ring 106a is preferably no smaller in diameter than the inner diameter of the stator 102. Further, any geometry can be used for the shape of the voltage phase terminals, including a polygon, such as a regular polygon of n sides inscribing or circumscribing a circle having a radius r, where the circle is associated with the radial dimension of the stator. The phase voltage terminals 106a, 106b, 106c can be made of any electrically conductive material, for example, copper or a copper alloy.

The width and the thickness of the phase voltage terminals 106a, 106b, 106c can vary. And, the phase voltage terminals 106a, 106b, 106c are radially separated from each other and arranged so as not to contact the stator windings 104. For example, in the exemplary embodiment shown in FIG. 1, one or more spacers 116 are positioned between the individual phase voltage terminals 106a, 106b, 106c. The number of spacers 116 and the radial separation distance between any two phase voltage terminals 106a, 106b, 106c are sufficient to prevent contact between the phase voltage terminals 106a, 106b, 106c. For example, three spacers 116 can be distributed approximately equally around the circumference of the phase voltage terminal arrangement 106, e.g., separated by 120°. Further, attaching the phase voltage terminals 106a, 106b, 106c to a spacer 116, e.g., by a pressure fit, a friction fit, adhesive, or mechanical connection, can maintain a constant separation distance between the phase voltage terminals 106a, 106b, 106c.

The polyphase machine 100 has a casing 118 enclosing the stator 102 and one or more of the spacers 116 can be adjacent the inner bore 120 of the casing 118, e.g., the radially outward end 122 of the spacer 116 can rest on the inner bore 120 or be proximate the inner bore 120 or at least one of the spacers 116 has a length such that the radially outward end 122 protrudes radially past the outer concentric ring 106c to rest on or be proximate the inner bore 120. The casing 118 can be a cylindrically shaped shell or any other suitable shape that is designed to protect the components of the polyphase machine 100 and optionally provide cooling passages for heat transfer.

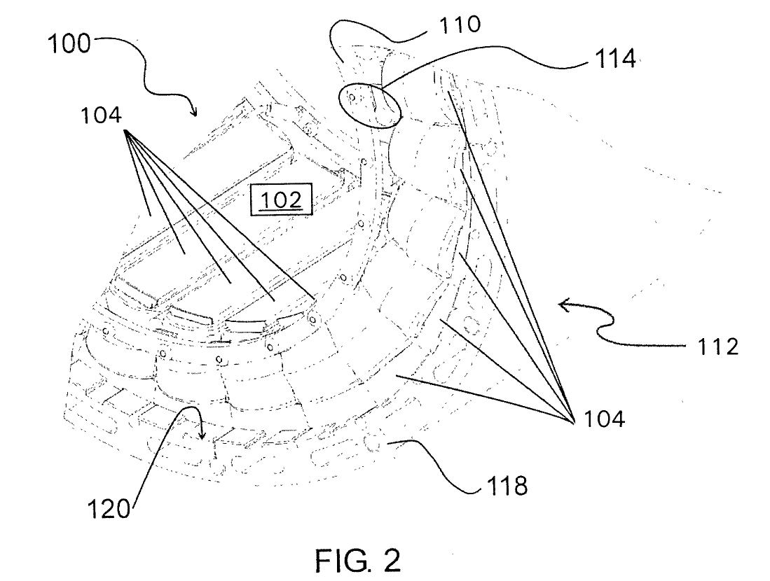

FIG. 2 shows a perspective view of the polyphase machine 100 as seen from the neutral terminal end 112. In the exemplary embodiment shown, a single neutral terminal 110 is shown at the neutral terminal end 112, but any number of neutral terminals can be used. The neutral terminal 110 preferably has a common axis with the stator 102 and can have a general shape corresponding to the radial cross section of the stator 102. For example, the neutral terminal 110 preferably is a single ring having a common axis with the stator 102 and a diameter that is no smaller than an inner diameter of the stator 102 and no larger than an outer diameter of the stator 102. Further, any geometry can be used for the shape of the neutral terminal 110, including a polygon, such as a regular polygon of n sides inscribing or circumscribing a circle having a radius r, where the circle is associated with the radial dimension of the stator. The neutral terminal 110 can be made of any electrically conductive material, for example, copper or a copper alloy.

Each of the leads from the stator windings 104 is fastened to a corresponding one of the phase voltage terminals 106a, 106b, 106c or neutral terminal 110 by a connection 114. All of the stator windings 104 having a common phase are fastened to the same phase voltage terminal. The connection 114 to the neutral terminal 110 is made such that all the stator windings 104 are preferably fastened to a single neutral terminal 110.

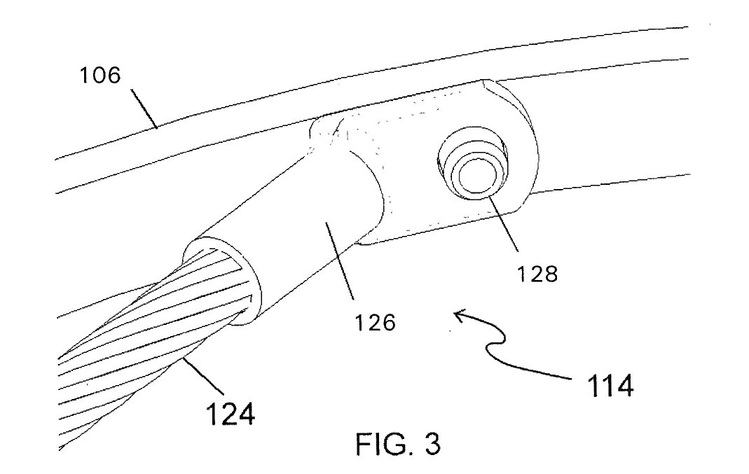

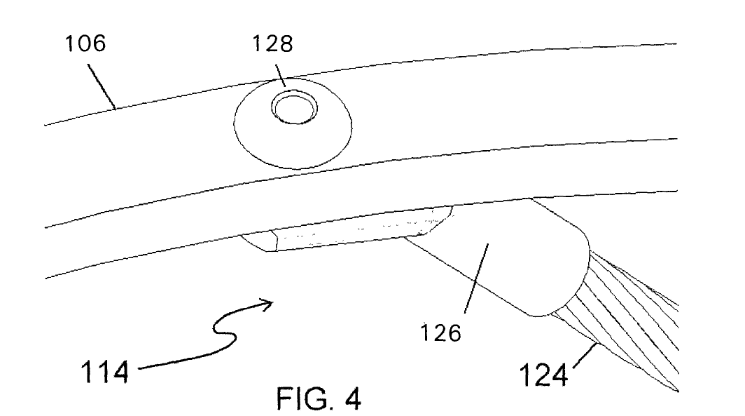

The connection 114 of the preferred embodiment is preferably a two part connection. In the exemplary embodiment shown in FIGS. 3 and 4, the connection 114 is represented by lead wire 124 protruding from the stator winding 104. In a first part of the two part connection, the lead wire 124 is preferably secured to a connector 126, such as a connector including a ring lug. The lead wire 124 can be attached to the connector 126 by any suitable method, including both solder and solderless methods and other methods known in the art such as crimping-based methods. In a second part of the two part connection, the connector 126 is preferably fastened to a respective phase voltage terminal 106a, 106b, 106c with a mechanical fastener 128. The mechanical fastener 128 is preferably a solderless fastener, such as a rivet, a threaded rivet, a screw, a bolt with a nut, or any suitable threaded fastener or blind fastener. In an exemplary embodiment, the mechanical fastener 128 is a threaded rivet, such as a RIVSCREW® threaded rivet available from Textron Fastening Systems of Troy, Mich. The mechanical fastener 128 preferably passes through the connector, for example the ring lug, and an opening, such as a hole, in the phase voltage terminal 106a, 106b, 106c.

Preferably, the mechanical fastener 128 is a reconnectable type of fastener, which can be released and refastened. One advantage of some of the embodiments of the present invention is that the fastener, if it is a reconnectable type, such as a threaded rivet or a nut and bolt, can be easily removed to change the connections. Accordingly, such embodiments provide not only an ease of assembly, but also provide ease of disassembly. As a result, the present invention provides a more versatile connection than that which has been previously used.

In an alternative embodiment of the present invention, the lead wire 124 can be secured to the terminal ring with a one part solderless fastener.

The phase voltage terminals 106a, 106b, 106c can be held in place by any suitable means and the phase voltage terminal arrangement 106 is offset from the stator windings 104. In an exemplary embodiment, the phase voltage terminals 106a, 106b, 106c are held in an axially offset position from the stator windings 104 by the connection 114, such as the stiffness of the wire leads 124 and/or the length and orientation of the connector 126.

The neutral terminal 110 can be held in place by any suitable means and is offset from the stator windings 104. In an exemplary embodiment, the neutral terminal 110 is held in an axially offset position from the stator windings 104 by the connection 114, such as the stiffness of the wire leads 124 and/or the length and orientation of the connector 126.

In an exemplary method for connecting parallel stator windings in a polyphase machine having a plurality of stator windings, a phase voltage end of at least one stator winding, preferably each stator winding, associated with a first phase of the polyphase machine is electrically connected to a corresponding first phase voltage terminal with a mechanical fastener. The mechanical fastener can fasten a lead wire protruding from the stator winding and terminated with a connector to the phase voltage terminal. In a preferred embodiment, the connecting step does not using a heat induced joining method.

Similarly, a phase voltage end of at least one stator winding, preferably each stator winding, associated with a second phase of the polyphase machine can be electrically connected to a corresponding second phase voltage terminal with a second mechanical fastener. The second mechanical fastener can fasten a lead wire protruding from the stator winding and terminated with a connector to the phase voltage terminal. A neutral terminal end of the stator windings can be electrically connected to a neutral terminal. The mechanical fastener can include riveting the connector and the phase voltage terminal. Other suitable mechanical fasteners include a screw, a bolt with a nut, and other threaded or blind fasteners.

Additionally, phases of the polyphase machine are similarly electrically connected to a phase voltage terminal and the common neutral terminal. In an exemplary method for a three phase polyphase machine, a phase voltage end of at least one stator winding, preferably each stator winding, associated with a third phase of the polyphase machine can be electrically connected to a corresponding third phase voltage terminal with a third mechanical fastener. The third mechanical fastener can fasten a lead wire protruding from the stator winding and terminated with a connector to the phase voltage terminal.

The method can be repeated as necessary according to the number of phases in the polyphase machine. In polyphase machines, one of the coil ends is attached to one of the phase voltage terminals of the machine and the other end is attached to the neutral terminal of the machine. On the phase voltage side, for each phase voltage applied, there is a separate, independent phase voltage terminal, e.g., one of the series of three concentric rings. On the common or neutral terminal side, there is a neutral terminal common to all of the windings, e.g., the neutral terminal ring. The same type of terminal can be used to couple both the phase voltage side and the neutral terminal side of the stator windings. For example in a three-phase electric motor, there are three separate phase voltage terminals and one neutral terminal. Each stator winding is attached to one of the phase voltage terminals, according to phase, on one end and typically attached to the one neutral terminal on the other or opposite end.

The plurality of phase voltage terminals and the single neutral terminal can allow parallel windings in the stator with a balanced dissipation of thermal and electrical energy. Furthermore, parallel windings can allow a designer to define the machine electromagnetic characteristics with better resolution. For example, in combination with parallel windings, common polyphase motors or generators can have shorter end turns, which can decrease the thermal loss in the stator windings due to a smaller resistance in the coils of the stator windings. Further, a polyphase motor can be more compact for a parallel winding design. Therefore, the motor becomes less cluttered and less expensive because of the required amount of wire and the assembly time is decreased.

An additional advantage is that the length of the wire that connects the phase voltage terminals and the neutral terminal to the stator is short compared to previous methods. This results in lower resistance in the wires, less heat generation, and more even heat generation and dissipation, thus leading to greater efficiency of the machine.

The mechanical fastener, e.g., the rivet, threaded rivet, screw, bolt with a nut, or any suitable threaded fastener or blind fastener, offers an equal or better conductivity connection than conventional methods, such as brazing and soldering. The mechanical fastener is also a simple mechanical coupling and, when installed, reduces the possibility of damaging other components in the machine, e.g., damage caused from the heat of brazing and soldering methods. A high electrically conductive connection is made with the mechanical fastener that offers a long life securely assembled with little to no chance of failure with the connection itself or the machine as a whole. In addition, assembly time can be reduced and the amount and type of materials are reduced and/or less expensive, thereby promoting manufacturing efficiencies over prior art methods.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A polyphase machine, comprising:
a stator having a plurality of parallel stator windings;
a plurality of phase voltage terminals, each of the stator windings fastened to a corresponding phase voltage terminal; and
at least one neutral terminal, each of the stator windings forming a common ground fastened to the neutral terminal,
wherein at least one of the stator windings is fastened to the corresponding phase voltage terminal or neutral terminal by a connection that does not involve a heat induced joining method.

2. The polyphase machine of claim 1, wherein the phase voltage terminals are a series of three concentric rings having a common axis with the stator.

3. The polyphase machine of claim 2, wherein a diameter of an innermost concentric ring is no smaller than an inner diameter of the stator, and a diameter of an outermost concentric ring is no larger than an outer diameter of the stator.

4. The polyphase machine of claim 1, wherein the solderless connection comprises a lead wire protruding from the stator winding and terminated with a connector that is fastened to the phase voltage terminal or the neutral terminal with a mechanical fastener.

5. The polyphase machine of claim 4, wherein the mechanical fastener is a rivet, a threaded rivet, a screw, or a bolt with a nut.

6. The polyphase machine of claim 4, wherein the mechanical fastener includes a threaded fastener or a blind fastener.

7. The polyphase machine of claim 4, wherein the connector includes a ring lug.

8. The polyphase machine of claim 5, wherein the connector includes a ring lug.

9. The polyphase machine of claim 6, wherein the connector includes a ring lug.

10. The polyphase machine of claim 5, wherein the phase voltage terminals are held in a position axially offset from the stator by the lead wires.

11. The polyphase machine of claim 5, comprising a rotor operatively positioned with the stator.

12. A polyphase machine, comprising:
a stator having a plurality of stator windings;
a plurality of phase voltage terminals, each of the stator windings fastened to a corresponding phase voltage terminal; and
at least one neutral terminal, each of the stator windings forming a common ground fastened to the neutral terminal,
wherein at least one of the stator windings is fastened to the corresponding phase voltage terminal or neutral terminal by a mechanical connection including a mechanical fastener selected from the group consisting of a threaded fastener and a blind fastener

13. The polyphase machine of claim 12, wherein the mechanical connection does not involve a heat induced joining method.

14. The polyphase machine of claim 12, wherein the mechanical connection comprises a lead wire protruding from the stator winding and terminated with a connector that is fastened to the phase voltage terminal or the neutral terminal by the mechanical fastener.

15. The polyphase machine of claim 14, wherein the connector includes a ring lug.

16. The polyphase machine of claim 12, wherein the threaded fastener is a threaded rivet, a screw, or a bolt with a nut.

17. The polyphase machine of claim 12, wherein the blind fastener is a rivet.

18. A polyphase machine, comprising:
a stator having a plurality of parallel stator windings;
a plurality of phase voltage terminals, each of the stator windings fastened to a corresponding phase voltage terminal; and
at least one neutral terminal, each of the stator windings forming a common ground fastened to the neutral terminal,
wherein at least one of the stator windings is fastened to a respective terminal with a two part connection, the two part connection including a connector secured to an end of the at least one stator winding and a fastener for securing the connector to the respective terminal, wherein the fastener does not use a heat induced joining method.

19. A method for connecting parallel stator windings in a polyphase machine having a plurality of stator windings, the method comprising:
electrically connecting a lead wire protruding from a stator winding and terminated with a connector to a corresponding phase voltage terminal with a mechanical fastener, the connecting step not using a heat induced joining method; and
electrically connecting a neutral terminal end of at least one stator winding to a neutral terminal.

20. The method of claim 19, wherein the mechanical fastener is rivet, a threaded rivet, a screw, or a bolt with a nut.
